(19) United States
(12) Patent Application Publication
(10) Pub. No.: US 2015/0131317 A1
(43) Pub. Date: May 14, 2015

(54) ILLUMINATION DEVICE, AND DISPLAY DEVICE

(71) Applicant: Sharp Kabushiki Kaisha, Osaka (JP)

(72) Inventors: Ryuzo Yuki, Osaka (JP); Takeshi Ishida, Osaka (JP)

(73) Assignee: Sharp Kabushiki Kaisha, Osaka (JP)

(21) Appl. No.: 14/402,879

(22) PCT Filed: May 24, 2013
(86) PCT No.: PCT/JP2013/064448

§ 371 Date: Nov. 21, 2014

(30) Foreign Application Priority Data
May 30, 2012 (JP) 2012-122887

(51) Int. Cl. F21V 8/00

(52) U.S. Cl. CPC G02B 6/002; G02B 6/0055; G02B 6/0073; G02B 6/0036
USPC 362/610

(57) ABSTRACT

The present invention aims at providing an illumination device and a display device that can suppress uneven brightness while improving light use efficiency and brightness. The illumination device includes a plurality of light sources arranged next to each other, a light guide member that guides light from the light sources, and protrusions that protrude towards the respective light sources from an end face of the light guide member. The protrusions each have side faces formed such that light emitted so as to spread in the arrangement direction of the light sources exits the light guide member and then re-enters from the end face thereof.

### TECHNICAL FIELD

The present invention relates to an illumination device having a light guide member that guides light, and to a display device having this illumination device.

### BACKGROUND ART

In a liquid crystal display device (display device) having a liquid crystal display panel (display panel), which does not emit light, a backlight unit (illumination device) that supplies light is usually provided for the liquid crystal panel. The backlight unit is configured to emit planar light of a uniform brightness towards the entire planar liquid crystal panel. Some backlight units have a light guide plate (light guide member) that widely diffuses light from a light source to make the brightness thereof uniform.

An edge-lit (side-lit) backlight unit, for example, is known as a backlight unit that has this light guide plate. The edge-lit backlight unit generally has the light sources arranged near a side face or side faces of the light guide plate. In a backlight unit having this configuration, light emitted by the light sources enters the inside of the light guide plate from the side face or side faces thereof. The light that has entered is guided (diffused) inside the light guide plate and exits towards the liquid crystal display panel as planar light.

In recent years, an increasing amount of backlight units use light-emitting diodes (LEDs) as light sources. LEDs are small compared to fluorescent lamps (cold cathode fluorescent lamps and the like), which have traditionally been used as the light sources, and can have simplified driving circuits due to having a low driving voltage, thereby making it possible for the backlight unit to be made smaller and thinner. LEDs also have less power consumption than fluorescent lamps and can reduce energy usage (power consumption).

On the other hand, when using point light sources such as LEDs for light sources in an edge-lit backlight unit, it is often difficult to have the light enter the wide light guide plate in a uniform manner. Therefore, backlight units that use LEDs for light sources are susceptible to bright lines (V-shaped bright lines) occurring in the diffusion shape of the LEDs and to having uneven brightness of planar light. To mitigate this type of uneven brightness, Japanese Patent Application Laid-Open Publication No. 2002-169034 proposes an illumination device (light guide plate) that can emit uniform light even when using point light sources such as LEDs or the like, for example.

Japanese Patent Application Laid-Open Publication No. 2002-169034 discloses an illumination device in which trapezoidal protrusions are provided in locations on the light guide plate corresponding to the point light sources, and symmetrical triangular or trapezoidal shaped through-holes are provided in these trapezoidal protrusions. In this illumination device, light from the light sources spreads to the left and right after entering the light guide plate by being reflected by the side faces of the trapezoidal protrusions or the side faces of the through-holes. This makes it possible to achieve exiting light (planar light) that has a uniform brightness.

### RELATED ART DOCUMENT

### Patent Document

Patent Document 1: Japanese Patent Application Laid-Open Publication No. 2002-169034

### SUMMARY OF THE INVENTION

### Problems to be Solved by the Invention

The illumination device in Japanese Patent Application Laid-Open Publication No. 2002-169034, however, can mitigate uneven brightness, but the shape thereof is complex and peculiar, which makes precise forming of these shapes a necessity. Thus, the manufacturing of this light guide plate is difficult and leads to an increase in costs.

In the illumination device in Japanese Patent Application Laid-Open Publication No. 2002-169034, through-holes are formed in the light guide plate (trapezoidal protrusions), and most of the light emitted from the LEDs passes through these through-holes, thereby increasing Fresnel reflection loss. Thus, light loss increases and light use efficiency decreases.

Even if the protruding structures are formed as described above, the slanted faces of the protrusions are formed along the direction in which light from the LEDs is diffused; thus, sometimes light emitted from the LEDs does hit the slanted faces in the vicinity of the LEDs, which can make it difficult to reduce V-shaped bright lines in the vicinity of the LEDs.

The present invention aims at providing an illumination device and a display device that can suppress uneven brightness while improving light use efficiency and brightness.

The present invention also aims at providing an illumination device and display device that can be made thin and is low-cost.

### Means for Solving the Problems

To achieve the above-mentioned aims, the present invention provides an illumination device, including: a plurality of light sources arranged in a line; a light guide member that guides light from the light sources; and protrusions that protrude towards the respective light sources from an end face of the light guide member adjacent to the light sources, the light from the light sources entering the respective protrusions, wherein the protrusions each have side faces formed such that, among the light that has entered the respective protrusions, light spreading in an arrangement direction of the light sources exits to outside of the respective protrusions and then re-enters the light guide member at the end face thereof.

With this configuration, light that has entered the protrusions refracts when exiting from the side faces of the protrusions. The light that exits from the side faces of the protrusions is also refracted when re-entering the light guide member through the end face thereof. The emission angle of the light becomes narrower due to the light being refracted when exiting the side faces of the protrusions and when re-entering the light guide member at the end face thereof. This makes it possible to suppress the occurrence of V-shaped bright lines, which is caused by light emitted from adjacent light sources overlapping each other, thereby allowing for a suppression of uneven brightness of planar light. With this configuration, the light that would have become V-shaped bright lines is refracted and usable, thereby making it possible to improve light use efficiency and luminosity.

In the above-mentioned configuration, the protrusions may each have a light receiving face where the light from the respective light sources enters, and a width of the light receiving face may be greater than a width of a light emitting part of the respective light sources.

In the above-mentioned configuration, the side faces of the respective protrusions may be formed so as to be progressively closer to an optical axis of the light of the respective light sources further away from the light sources.

In the above-mentioned configuration, the side faces of the respective protrusions may include a first side face and a second side face that are symmetric with an optical axis of the light from the respective light sources.

In the above-mentioned configuration, each of the protrusions may be formed in a trapezoidal shape as seen from a front thereof, and slants of the trapezoidal-shaped protrusions may be the side faces of the protrusions.

In the above-mentioned configuration, an angle of the respective side faces to an optical axis of the light from the respective light sources is configured such that light that has re-entered from the end face of the light guide member is parallel to the optical axis and does not mix with light from adjacent light sources.

The above-mentioned configuration may further include a reflective member that covers at least the side faces of the protrusions and a front side of a portion of the end face of the light guide member where light re-enters.

In the above-mentioned configuration, the light guide member includes a light guide body where the light from the light sources enters, and a low refractive index layer that is disposed on a rear surface of the light guide body without having an air layer therebetween and that has a lower refractive index than the light guide body.

The above-mentioned configuration may further include a prism layer formed on a surface of the low refractive index layer opposite to the light guide body without having an air layer therebetween, the prism layer having prisms on a side thereof opposite to the low refractive index layer.

One example of a device using the above-mentioned illumination device includes a display device having a display panel that receives light from this illumination device. A backlight can be one example of the illumination device. A liquid crystal display device can be one example of the display device.

### EFFECTS OF THE INVENTION

According to the present invention, it is possible to provide an edge-lit backlight device that can suppress energy consumption and that can emit planar light having a uniform brightness distribution with a simple configuration.

### BRIEF DESCRIPTION OF THE DRAWINGS

FIG. 1 is a schematic perspective view of one example of a backlight unit, which is an illumination device, according to the present invention.

FIG. 2 is a side view of the backlight unit in FIG. 1.

FIG. 3 is a schematic perspective view of a light guide plate used in the backlight unit shown in FIG. 2.

FIG. 4 is a cross-sectional view in which the light exiting section of the light guide plate shown in FIG. 3 has been enlarged.

FIG. 5 is a cross-sectional view of the light guide plate shown in FIG. 3.

FIG. 6 is a cross-sectional view in which the rear side of the light guide plate shown in FIG. 3 has been enlarged.

FIG. 7 is a front view in which the vicinity of the light receiving section of the light guide plate in the backlight unit of the present invention has been enlarged.

FIG. 8 is a view in which a portion of FIG. 9 has been enlarged to show the optical path of light.

FIG. 9 is a view of when V-shaped bright lines have occurred during use of a conventional light guide plate and LEDs as light sources.

FIG. 10 is a view of the angular distribution of light in the respective areas in FIG. 7.

FIG. 11 is a view of the angular distribution of light emitted from an LED.

FIG. 12(A) is a view of an initial state before light at the horizontal portions of the circumference have passed through side faces (trapezoidal prisms), and FIG. 12(B) is a view of after light at the horizontal portions of the circumference has been refracted at the side faces and end faces (after refraction at the slanted faces).

FIG. 13 is a view of simulation results of the inhibitory effects of V-shaped bright lines with the illumination device of the present invention.

FIG. 14 is a view of simulation results when V-shaped bright lines have occurred with a conventional illumination device.

FIG. 15 is a side view of one example of the light guide plated using in the backlight (illumination device) of the present invention.

FIG. 16 is a front view of another example of the backlight unit (illumination device) of the present invention.

FIG. 17 is a side view of the backlight unit in FIG. 16.

FIG. 18 is a view of a modification example of the backlight unit in FIG. 16.

FIG. 19 is a view of a modification example of the backlight unit in FIG. 9.

FIG. 20 is a view of another modification example of the backlight unit in FIG. 9.

FIG. 21 is a view of a modification example of the backlight unit in FIG. 2.

FIG. 22 is a view of a modification example of the backlight unit in FIG. 5.

FIG. 23 is a front view of another example of the backlight unit (illumination device) of the present invention.

FIG. 24 is a view in which a vicinity of a protrusion of the backlight unit in FIG. 23 has been enlarged.

FIG. 25 is a front view of another example of the backlight unit (illumination device) of the present invention.

FIG. 26 is a front view of another example of the backlight unit (illumination device) of the present invention.

FIG. 27 is an exploded perspective view of a liquid crystal display device, which is one example of a display device, according to the present invention.

### DETAILED DESCRIPTION OF EMBODIMENTS

Embodiments of the present invention will be explained below with reference to the drawings.

### Embodiment 1

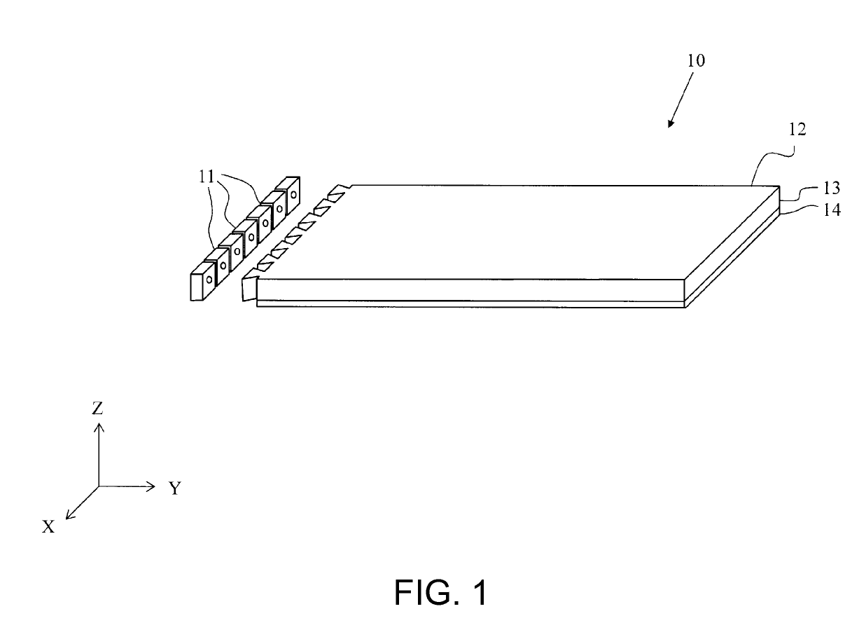

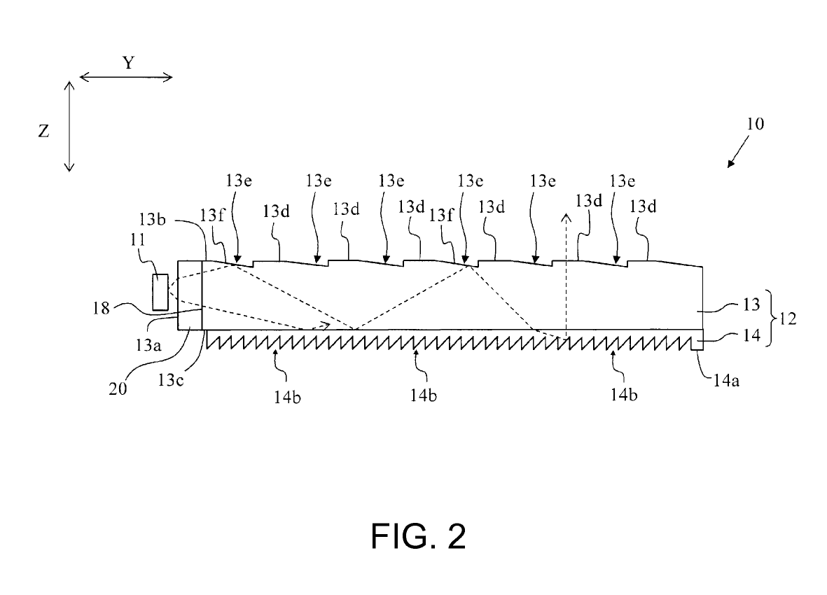

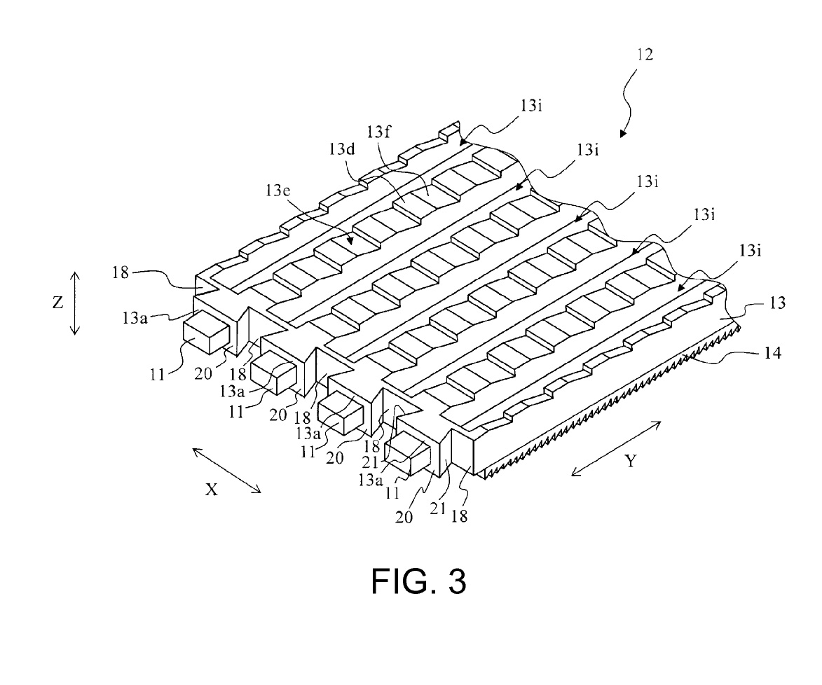

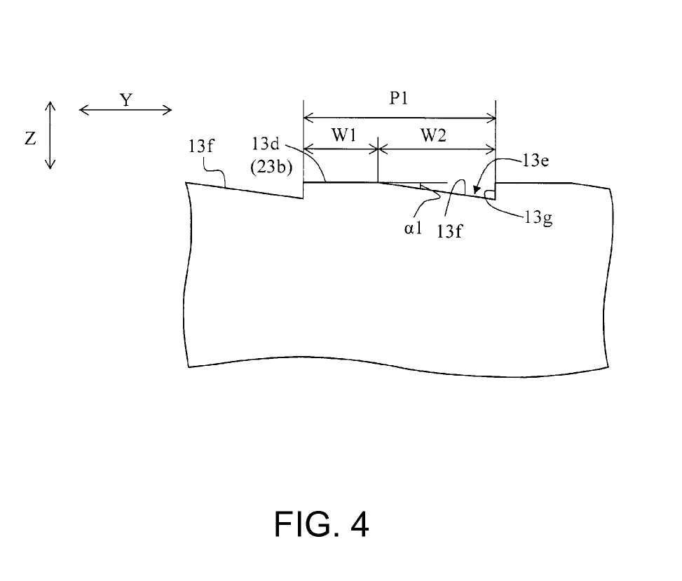

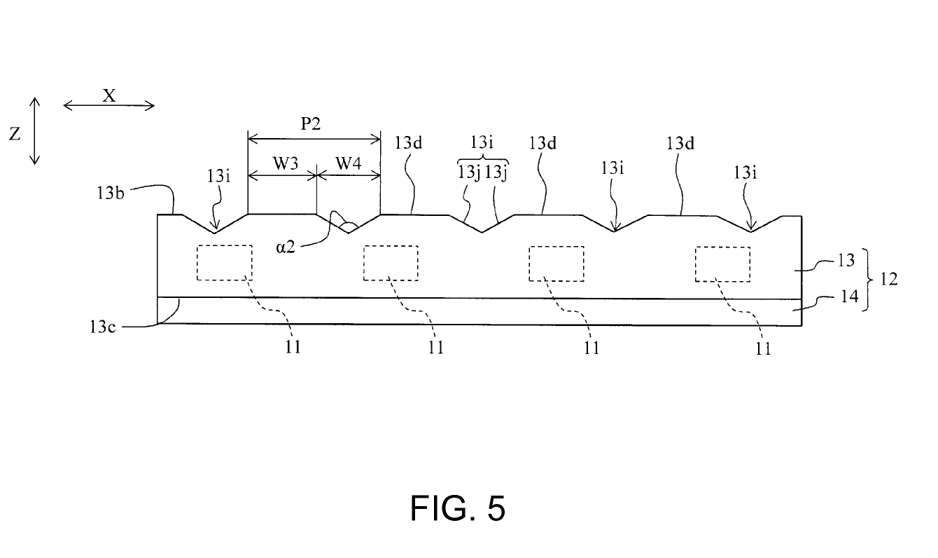

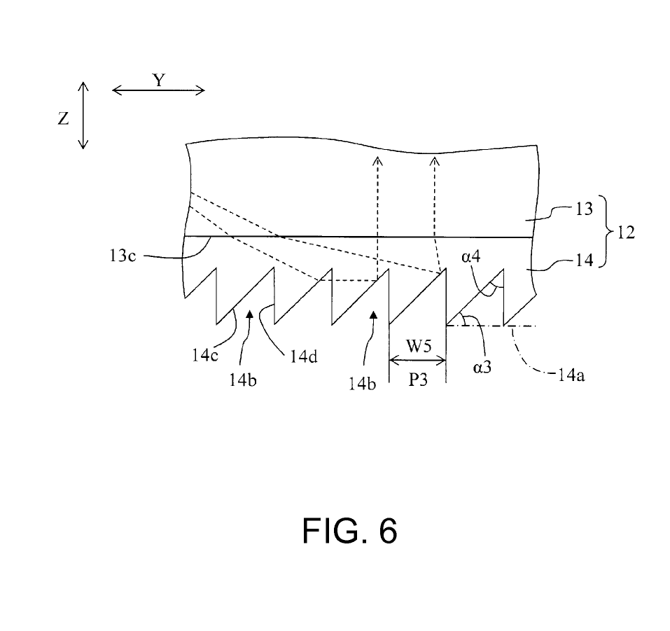

FIG. 1 is a schematic perspective view of one example of a backlight unit, which is an illumination device, according to the present invention. FIG. 2 is a side view of the backlight unit in FIG. 1. FIG. 3 is a schematic perspective view of a light guide plate used in the backlight unit shown in FIG. 2. FIG. 4 is a cross-sectional view in which the light exiting section of the light guide plate shown in FIG. 3 has been enlarged. FIG. 5 is a cross-sectional view of the light guide plate shown in FIG. 3. FIG. 6 is a cross-sectional view in which the rear side of the light guide plate shown in FIG. 3 has been enlarged. First, the shape of the backlight unit of the present invention will be explained. Hereinafter, the width direction of the backlight unit will be described as the X direction, the lengthwise direction as the Y direction, and the thickness direction as the Z direction.

A backlight unit 10 is an edge-lit backlight unit. As shown in FIGS. 1 and 2, this backlight unit 10 includes LEDs 11 as light sources and a light guide plate 12 that guides light emitted by these LEDs 11. The backlight unit 10 has a plurality of these LEDs 11, which are arranged next to each other in the width direction (X direction, see FIG. 1) of the light guide plate 12.

The light guide plate 12 is a transmissive plate-shaped member. The light guide plate 12 is constituted of a light guide body 13 that guides light and a low refractive index layer 14 that has a lower refractive index than the light guide body 13. As shown in FIG. 2, the light guide body 13 has a light receiving section 13a where light from the LEDs 11 enter and a light exiting section 13b where light that has been guided inside the light guide plate 12 exits as planar light.

As shown in FIG. 2, the light guide body 13 has a substantially cuboid shape. In other words, the light guide body 13 is formed so as to be substantially parallel to the light exiting section 13b and a rear surface 13c. The light receiving section 13a of the light guide body 13 is disposed so as to be substantially parallel to the light emitting sections of the LEDs 11.

The light guide body 13, which forms a portion of the light guide plate 12, is made of a transmissive resin material such as acrylic or polycarbonate, for example. If the light guide body 13 is made of acrylic or the like, then it is possible for the refractive index of the light guide body 13 to be approximately 1.49. If the light guide body 13 is made of polycarbonate or the like, then it is possible for the refractive index of the light guide body 13 to be approximately 1.59. When the light guide body 13 is made of acrylic, the transmissive characteristics thereof can be improved more than if the light guide body 13 is made of polycarbonate.

As shown in FIGS. 2 and 3, the low refractive index layer 14 is attached to the rear surface 13c of the light guide body 13 and is integrally formed with the light guide body 13 and the low refractive index layer 14. This low refractive index layer 14 has a thickness of approximately 10 μm to approximately 50 μm, for example.

The low refractive index layer 14 is made of a transmissive resin material that has a lower refractive index than the light guide body 13. Examples of this type of resin material include fluorine-based acrylate and resin that has hollow particles such as nano-sized inorganic fillers. If the low refractive index layer 14 is made of fluorine-based acrylate or the like, then it is possible for the refractive index of the low refractive index layer 14 to be approximately 1.35. If the low refractive index layer 14 is made of a resin having hollow particles such as nano-sized inorganic fillers or the like, then it is possible for the refractive index of the low refractive index layer 14 to be 1.30 or less.

It is preferable that a refractive index (n1) of the light guide body 13 be at least 1.42, and even more preferably be 1.59 to 1.65. Meanwhile, it is preferable that a refractive index (n2) of the low refractive index layer 14 be under 1.42, and even more preferably be 1.10 to 1.35. It is also preferable that a relationship of n1/n2>1.18 be established between the refractive index (n1) of the light guide body 13 and the refractive index (n2) of the low refractive index layer 14.

As shown in FIG. 2, a plurality of first prisms 13e having an angle of incidence of light from the LEDs 11 with respect to the rear surface 13c that becomes progressively smaller away from the LEDs 11 are provided on the light exiting section 13b of the light guide body 13. Specifically, a plurality of planar sections 13d and a plurality of the recessed first prisms 13e are alternately formed on the light exiting section 13b of the light guide body 13 along the direction normal to the light receiving section 13a of the light guide body 13 (the Y direction/the direction orthogonal to the X direction). In other words, the planar sections 13d are respectively formed between the first prisms 13e adjacent in the Y direction. These planar sections 13d and first prisms 13e are respectively formed so as to extend in the X direction (see FIG. 3).

The planar sections 13d are formed in the same plane as the light exiting section 13b and are substantially parallel to the rear surface 13c. As shown in FIG. 4, the planar sections 13d are formed so as to have a prescribed width W1 in the Y direction.

The recessed first prisms 13e are each constituted of a slanted face 13f that slants towards the respective planar sections 13d (i.e., slants towards the light exiting section 13b) and a vertical face 13g that is substantially perpendicular to the respective planar sections 13d (i.e., substantially perpendicular to the light exiting section 13b). As shown in FIG. 4, this slanted face 13f becomes progressively closer to the rear surface 13c further from the LEDs 11. By forming the first prisms 13e in this manner, light that is emitted from the LEDs 11 is repeatedly reflected between the slanted faces 13f (the first prisms 13e) and the rear surface 13c of the light guide body 13, thereby gradually narrowing the angle of incident of light from the LEDs 11 with respect to the rear surface 13c of the light guide body 13. As shown in FIG. 4, it is preferable that a slanted angle α1 of the slanted face 13f with respect to the planar section 13d be 5° or less, and even more preferably be 0.1° to 3.0°.

The slanted face 13f (first prism 13e) is formed so as to have a prescribed width W2 in the Y direction. It is preferable that the width W2 in the Y direction of this slanted face 13f (first prism 13e) be 0.25 mm or less, and more preferably be 0.01 mm to 0.10 mm. The slanted faces 13f (first prisms 13e) are arranged at a prescribed pitch P1 (=W1+W2) in the Y direction.

The width W1 of the planar sections 13d in the Y direction, the slant angle α1 of the slanted faces 13f, the width W2 of the slanted faces 13f (first prisms 13e) in the Y direction, and the pitch P1 of the slanted faces 13f (first prisms 13e) in the Y direction may be uniform regardless of distance from the LEDs 11. These numerical values may be made to change in accordance with the distance from the LEDs 11 or differ depending on prescribed ranges such that the angle of incidence of light inside the light guide plate 12 with respect to the rear surface 13c becomes smaller.

As shown in FIG. 5, a plurality of recessed second prisms 13i are formed next to each other at prescribed intervals on the light exiting section 13b of the light guide body 13 along the X direction. In other words, the planar sections 13d are respectively formed between the second prisms 13i adjacent in the X direction. The planar sections 13d are formed on the same plane as the light exiting section 13b. The planar sections 13d are formed so as to have a prescribed width W3 in the X direction.

The second prisms 13i are each constituted of a pair of slanted faces 13j slanted towards the respective planar sections 13d (the light exiting section 13b). The second prisms 13i have a recessed shape. In other words, the cross section of the second prisms 13i is a triangular shape. It is preferable that the angle α2 of each pair of slanted faces 13j to each other (i.e., the angle of one of the slanted faces of a pair with respect to the other slanted face of the same pair) be approximately 120° to 140° (the apex angle of the second prisms 13i).

The pairs of slanted faces 13j (second prisms 13i) are formed so as to have a prescribed width W4 in the X direction. It is preferable that the width W4 of these pairs of slanted faces 13j (second prisms 13i) in the X direction be approximately 0.1 mm or less, and even more preferably be approximately 0.010 mm to approximately 0.030 mm. It is preferable that a pitch P2 (=W3+W4) of the second prisms 13i in the X direction be P2≦W4x2. In other words, it is preferable that the width W3 of the planar sections 13d in the X direction be a size that is less than or equal to the width W4 of the pairs of slanted faces 13j in the X direction.

It is preferable that the second prisms 13i be formed having the same shape, same size, and same pitch regardless of the locations thereof in the light guide body 13. In other words, the width W3 of the planar sections 13d in the X direction, the angle (apexes of the second prisms 13i) α2 of the pairs of slanted faces 13j, the width W4 of the pairs of slanted faces 13j (second prisms 13i) in the X direction, and the pitch P2 of the pairs of slanted faces 13j (second prisms 13i) in the X direction are uniform.

The explanation of the light guide body 13 will be continued while referring back to FIG. 3. As shown in FIG. 3, in the light guide body 13, the first prisms 13e, and the second prisms 13i are formed so as to overlap on the same plane. The second prisms 13i function to diffuse light in the horizontal direction (X direction). It is preferable that the occupied area ratio of the second prisms 13i with respect to the total front view area of the first prisms 13e and the second prisms 13i be at least 50%.

A plurality of recessed rear prisms 14b are also formed on a rear surface 14a of the low refractive index layer 14 (rear surface of the light guide plate 12). These rear prisms 14b are formed on at least the entire light exiting region of the light guide plate 12. The rear prisms 14b are formed so as to extend in the X direction.

As shown in FIG. 6, the recessed rear prisms 14b are each constituted of a slanted face 14c that slants towards the rear surface 14a and a vertical face 14d that is perpendicular to the rear surface 14a.

The slanted faces 14c are formed flat and not curved. The slanted faces 14c become progressively closer to the light guide body 13 further from the LEDs 11. In this case, it is preferable that a slanted angle α3 of the respective slanted faces 14c to the rear surface 14a be approximately 40° to approximately 50°. In other words, it is preferable that an angle α4 of the slanted face 14c to the vertical face 14d be approximately 50° to approximately 40°.

The slanted faces 14c (rear prisms 14b) are each formed so as to have a prescribed width W5 in the Y direction. The width W5 of the slanted face 14c (rear prism 14b) in the Y direction is approximately 0.1 mm or less, and preferably approximately 0.010 mm to approximately 0.025 mm.

The slanted face 14c (rear prism 14b) is arranged in the Y direction at a pitch P3 that has the same size as the width W5. In other words, the plurality of rear prisms 14b are continually formed in the Y direction with no spaces therebetween, and there are no planar sections provided between the rear prisms 14b.

The rear prisms 14b may have the same shape, same size, and same pitch on substantially the entire rear surface 14a of the low refractive index layer 14, regardless of the locations thereof in the low refractive index layer 14. In this manner, if the rear prisms 14b are formed, then it is possible to suppress variations in the concentration characteristics of light in the low refractive index layer 14. This allows for planar light that exits the light exiting section 13b to have a uniform brightness. As described later, the rear prisms 14b function to totally reflect forward the light from the LEDs 11 at the interface of the light guide plate 12 and an air layer.

The light emitted by the LEDs 11 is repeatedly reflected between the first prisms 13e (light exiting section 13b) and rear surface 13c of the light guide body 13, and the angle of incidence of light from the LEDs with respect to the rear surface 13c of the light guide body 13 gradually becomes narrower. The light enters the low refractive index layer 14 when the angle of incidence with respect to the rear surface 13c becomes smaller than the critical angle.

Among the light that has entered the light receiving section 13a of the light guide body 13, the light traveling towards the rear surface 13c of the light guide body 13 is repeatedly reflected between the rear surface 13c of the light guide body 13 and the first prisms (light exiting section 13b) in a similar manner, thereby entering the low refractive index layer 14.

Thereafter, as shown in FIG. 6, substantially all of the light that has entered the low refractive index layer 14 is totally reflected forward (see the dotted arrows) at the slanted faces 14c of the rear prisms 14b (at the interface of the slanted faces 14c of the rear prisms 14b and the air layer) or totally reflected (see the dotted arrows) after passing through. The light that has been totally reflected (see the dotted arrows) at the rear prisms 14b (the slanted faces 14c) enters the light guide body 13 again and exits forward from the light exiting section 13b (see FIG. 2, etc.).

The refractive index (n1) of the light guide body 13 is at least 1.42 (approximately 1.59 to approximately 1.65), and the refractive index of the air layer is approximately 1; therefore, the critical angle of the light guide body 13 and the air layer is smaller than the critical angle of the light guide body 13 and the low refractive index layer 14. As a result, there is almost no light that exits from the light exiting section 13b without passing through the rear prisms 14b of the low refractive index layer 14. In other words, the light that has entered the light guide plate 12 (light guide body 13) from the light receiving section 13a enters the low refractive index layer 14 at one end, is reflected by the rear prisms 14b, and then exits from the light exiting section 13b after returning to the light guide body 13.

As shown in FIG. 5, the second prisms 13i are formed on the light exiting section 13b of the light guide body 13, and thus a portion of the light traveling towards the light exiting section 13b of the light guide body 13 is diffused (reflected) at both ends in the X direction at the slanted faces 13j of the second prisms 13i. At this time, as seen from the light receiving section 13a side of the light guide body 13, light that has a large angle of incidence to the light exiting section 13b of the light guide body 13 is reflected by the slanted faces 13j of the second prisms 13i, thereby narrowing the angle of incidence of this light with respect to the rear surface 13c of the light guide body 13. In other words, light from the LEDs 11 is diffused in the X direction by the second prisms 13i and then enters the low refractive index layer 14.

As described above, by providing the plurality of first prisms 13e that gradually narrow the angle of incidence of light from the LEDs 11 with respect to the rear surface 13c of the light guide body 13 on the light exiting section 13b of the light guide body 13, light from the LEDs 11 is guided while being repeatedly reflected between the light exiting section 13b and the rear surface 13c of the light guide body 13, thereby gradually narrowing the angle of incidence of light with respect to the rear surface 13c of the light guide body 13. Light having an angle of incidence to the rear surface 13c of the light guide body 13 that is less than the critical angle of the light guide body 13 and the low refractive index layer 14 enters the low refractive index layer 14. Therefore, the Y direction spread angle of the light entering the low refractive index layer 14 becomes narrower, and the Y direction spread angle of the light reflected at the interface of the rear surface 14a of the low refractive index layer 14 and the air layer also becomes narrower. In other words, it is possible to improve the concentration characteristics of light while also improving the brightness of the planar light. As a result, it is not necessary to provide a plurality of optical sheets such as condensing lens sheets on the light guide plate 12.

In the backlight unit 10 having the LEDs 11 and the light guide plate 12, the LEDs 11 are point light sources, and the distance from the LEDs 11 to the light receiving section 13a of the light guide plate 12 is short; thus, it becomes easy for V-shaped bright lines to occur in areas near the light receiving section 13a of the light guide plate 12 (in the vicinity of the light receiving section). When such V-shaped bright lines occur, there is a risk that the illumination quality in the areas near the light receiving section 13a will drop.

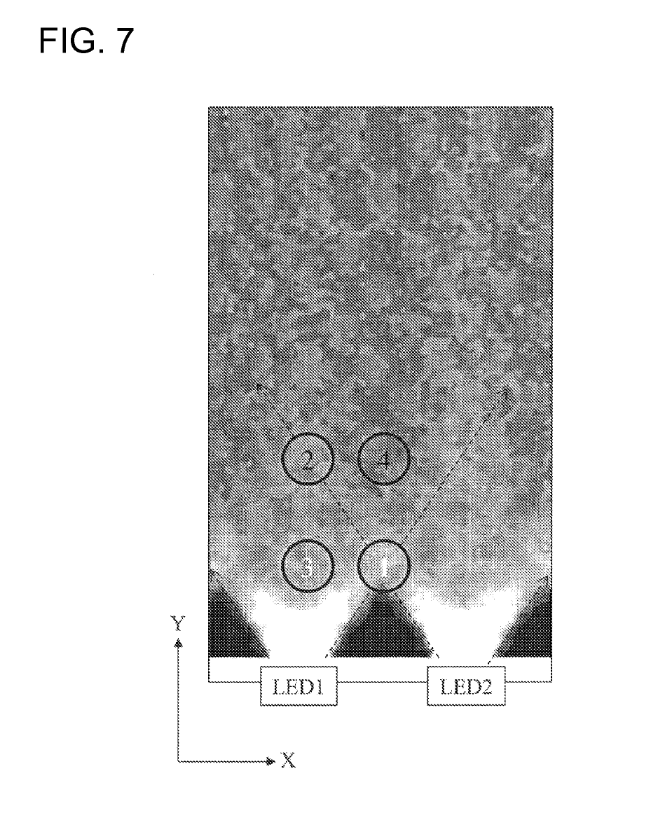

The V-shaped bright lines that occur in the vicinity of the light receiving section of the light guide plate 12 will be explained below with reference to the drawings. FIG. 7 is a view of when V-shaped bright lines have occurred during use of a conventional light guide plate and LEDs as light sources. As shown in FIG. 7, when using point light sources such as LEDs 11 as light sources, V-shaped bright lines (see the dotted lines) are susceptible to occurring in the vicinity of the light receiving section of the light guide plate 12. Therefore, the inventors of the present invention have performed various research into the causes of these V-shaped bright lines.

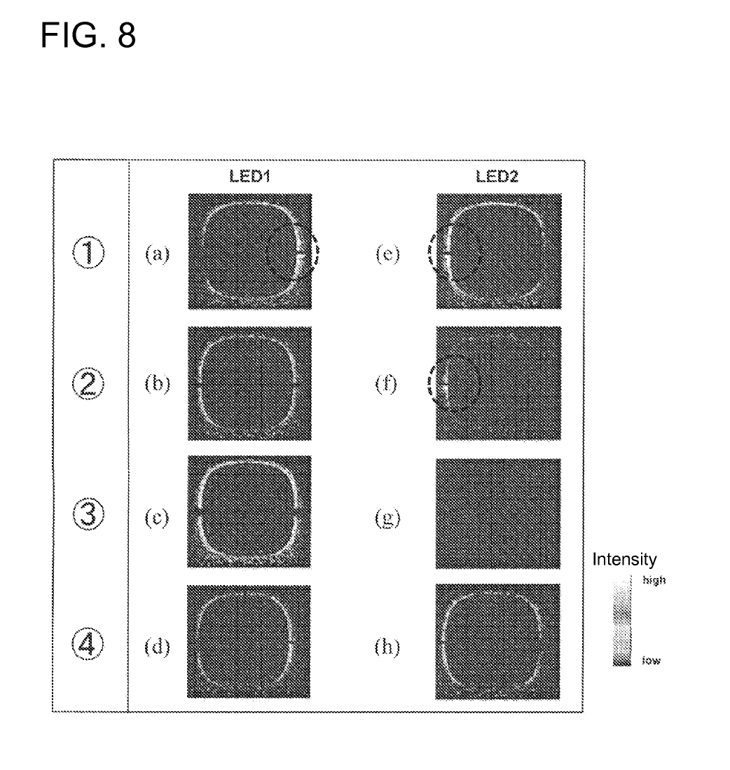

First, a simulation was performed to find what angles of light influence V-shaped bright lines in the distribution of light emitted from the LEDs (light sources). These results are shown in FIG. 8. FIG. 8 is a view of the angular distribution of light in the respective areas in FIG. 7. Area “1” is located in the respective V-shaped bright line portions of LED 1 and LED 2, and area “2” is located in the V-shaped bright line portions of LED 2. Meanwhile, area “3” and area “4” are located away from the V-shaped bright lines. FIGS. 8(a) to 8(d) show the distribution of light emitted from the LED 1 and FIGS. 8(e) to 8(h) shows the distribution of light from the LED 2.

It can be observed from FIG. 8 that, in area “1” located in the V-shaped bright line portion, the light intensity at the horizontal angle (the portion surrounded by the dotted line) for both LED 1 (FIG. 8(a)) and LED 2 (FIG. 8(e)) is strong, and this light forms the V-shaped bright line. Furthermore, area “2” is located in the V-shaped bright line portion of LED 2; therefore, in LED 2 (FIG. 8(f)), it is observed that the light intensity of the horizontal angle (the portion surrounded by the dotted line) is strong. Meanwhile, in areas “3” and “4” that are not located in the V-shaped bright line portions, the intensity of light of the horizontal angle is not strong, and the light intensity is approximately the same at any angular distribution. Thus, the light that forms the V-shaped bright lines is concentrated at the horizontal portions of the circumference (horizontal angles).

The above confirmed that the light at the horizontal angles are forming the V-shaped bright lines due to the angular distribution and the like of incident light. This is possibly due to the light at the horizontal angles exiting from the light exiting section 13b (see FIG. 5) in the vicinity of the light receiving section 13a. Specifically, the surface roughness of the light receiving section 13a of the light guide plate 12 and the first prisms 13e (see FIG. 2) and the second prisms 13i (see FIG. 5) formed on the light exiting section 13b influence the light at the horizontal angles in the vicinity of the light receiving section 13a such that the angle of incidence of the light with respect to the rear surface 13c of the light guide body 13 is at or below the critical angle of the light guide body 13 and the low refractive index layer 14. Due to this, the light enters the low refractive index layer 14 and is then reflected to the front side by the rear prisms 14b (see FIG. 2). The light then exits forward from the light exiting section 13b. This light is thought to become the V-shaped bright lines in the vicinity of the light receiving section 13a. In other words, it is believed that the V-shaped bright lines occur due to the light that is not totally reflected at the interface of the low refractive index layer 14 leaking towards the front.

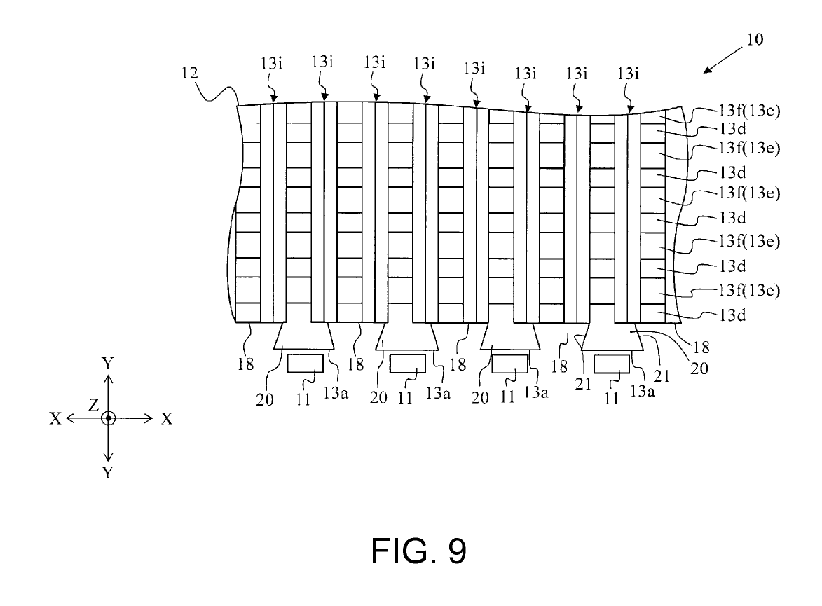

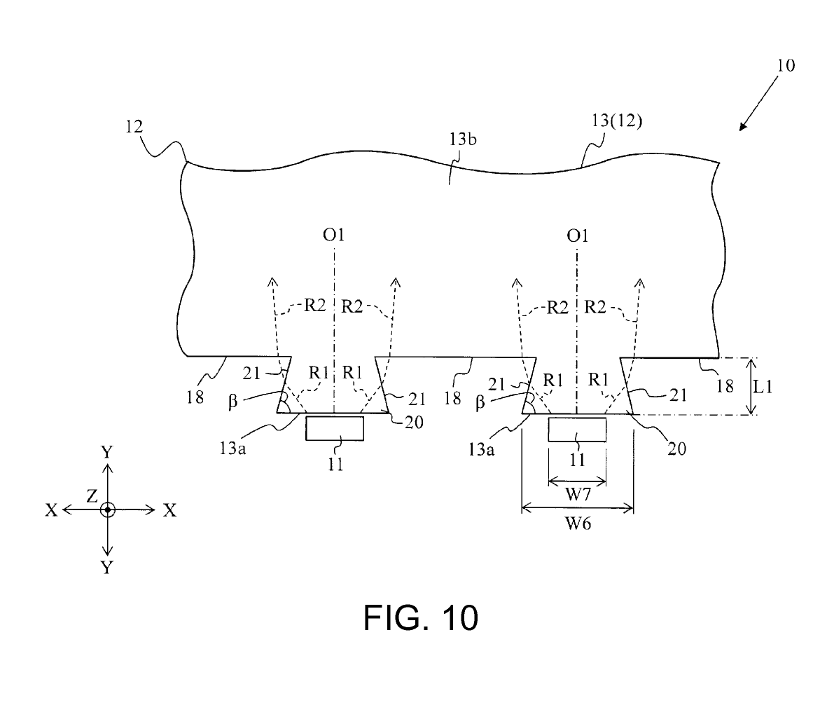

Therefore, in the backlight unit 10, the light guide plate 12 is formed so as to suppress the occurrence of V-shaped bright lines. FIG. 9 is a front view in which the vicinity of the light receiving section of the light guide plate of the backlight unit according to the present invention has been magnified, and FIG. 10 is a view in which a portion of the optical paths of light in FIG. 9 has been expanded.

As shown in FIG. 9, the light guide plate 12 is formed in integration with protrusions 20 that protrude towards the respective LEDs 11. These protrusions 20 are formed in a trapezoidal shape when seen from the front and each have side faces 21 and 21 arranged so as to be symmetrical to each other with an optical axis O1 of the LED therebetween. As shown in FIG. 10, the protrusions 20 are formed such that the longer of the upper base or the lower base of the trapezoid is close to the respective LEDs 11. The light guide plate 12 has one of the protrusions 20 for each of the LEDs 11 in areas facing the respective plurality of LEDs 11.

In other words, the protrusions 20 formed on the LED 11 side end of the light guide plate 12 are formed in integration with the light guide body 13, and thus it can be said that the protrusions 20 are trapezoidal prisms integrally formed on the LED 11 side end of the light guide plate 12. The side faces 21 and 21 are formed substantially perpendicular to the light exiting section 13b and the rear surface 13c of the light guide body 13. The side faces 21 and 21 are slanted from the light receiving section 13a towards the optical axis O1 (see FIG. 10), and become progressively closer to the optical axis O1 further away from the LEDs 11.

As shown in FIG. 9, the surface of the protrusions 20 facing the LEDs 11 is the light receiving section 13a, which is where light from the LEDs 11 enters the inside of the light guide plate 12. In other words, each of the protrusions 20 has the light receiving section 13a on a surface thereof facing the light emitting surface of the LED 11.

Light that is emitted from the LEDs 11 and then enters the inside of the light guide plate 13 from the light receiving section 13a exits to outside from the side faces 21 and 21 and then enters the light guide body 13 again at an end face 18 of the light guide body 13. In this manner, light is refracted by exiting from the light guide body 13 at the side faces 21 and 21. The refractive index of the light guide body 13 (n1) is higher than the refractive index of air (approximately 1). The side faces 21 and 21 become progressively closer to the optical axis O1 further from the LEDs 11; therefore, light that exits from the side faces 21 and 21 is refracted in a direction that approaches the optical axis O1 (a direction whose angle with respect to the optical axis O1 becomes progressively narrower). When this light enters the light guide body 13 again at the end face 18, the difference between the refractive index of the air (approximately 1) and the refractive index of the light guide body 13 (n1) refracts the light in a direction that approaches the optical axis O1.

As described above, among the light emitted from the LEDs 11, the light that is emitted in V-shaped bright lined directions refracts when passing through the side faces 21 and 21 of the protrusions 20 and refracts when passing through the end face 18 of the light guide body 13, thereby changing the angular distribution of the light in the horizontal direction. Due to this, light emitted from the LEDs 11 is made uniform and guided by the light guide body 13.

A width W6 of the light receiving section 13a in the X direction is configured so as to be larger than a width W7 of the LEDs 11. With this configuration, light from the LEDs 11 can be made to effectively enter the inside of the light guide plate 12 from the light receiving section 13a. Similar effects can be obtained if the width W6 of the light receiving section 13a is greater than the width of the light emitting portion of the LEDs 11. It is preferable that the protruding amount of the protrusions 20 (a distance L1 from the light receiving section 13a to the end face 18) be configured at such a length that light R2 emitted in the V-shaped bright line directions enters the side faces 21 and 21. The distance L1 can be approximately 3 mm, for example. An angle β of the side faces 21 and 21 to the light receiving section 13a is configured such that the light R2 emitted in the V-shaped bright line directions (see FIG. 10) enters the side faces 21 and 21 at an angle that is less than or equal to the critical angle. It is preferable that the angle be configured such that the light R2 that is emitted in the V-shaped bright line directions from the adjacent LEDs 11 and enters the light guide body 13 from the end face 18 is refracted so as not to overlap with each other (i.e., so as not overlap with other light R2).

When the refractive index (n1) of the light guide body 13 is 1.59 and the refractive index (n2) of the low refractive index layer 14 is 1.3, the V-shaped bright lines appear in a direction that is approximately 39° to the optical axis O1. If the width W7 of the LEDs 11 is approximately 2.2 mm and the width W6 of the light receiving section 13a is approximately 3 mm, and if the distance L1 from the light receiving section 13a to the end face 18 is approximately 3 mm and the angle β of the side faces 21 and 21 with respect to the light receiving section 13a is approximately 60° (if the slanted angle with respect to the optical axis O1 is approximately 30°), then among the light that has entered the light guide plate 12 from the light receiving section 13a, almost all of the light R2 emitted in the V-shape bright line directions enters the side faces 21 and 21 at an angle that is less than or equal to the critical angle.

As shown in FIG. 9, the formation areas of the second prisms 13i on the light guide plate 12 extend to the trapezoidal protrusions 20 (side faces 21 and 21), or namely, to the end face 18, but the present invention is not limited to this.

Meanwhile, as shown in FIG. 10, among the light from the LEDs 11 that has entered from the light receiving section 13a, the light R2 emitted in the V-shaped bright line directions refracts in a direction that approaches the optical axis O1 (a direction whose angle with respect to the optical axis O1 becomes progressively narrower) when passing through the side faces 21 and 21. Due to this, the light R2 having an angular distribution that becomes the V-shaped bright lines changes to light R2 having an angular distribution that does not become the V-shaped bright lines. Accordingly, this suppresses V-shaped bright lines from occurring.

When the protrusions are formed on the light guide plate 12, light refracts when passing through the side faces 21 and 21 of these protrusions 20, which changes the angular distribution of the light. This suppresses light from entering the low refractive index layer 14 (due to the light being totally reflected at the interface with the low refractive index layer 14), and suppresses light from leaking from the light exiting section 13b. Accordingly, this suppresses V-shaped bright lines from occurring.

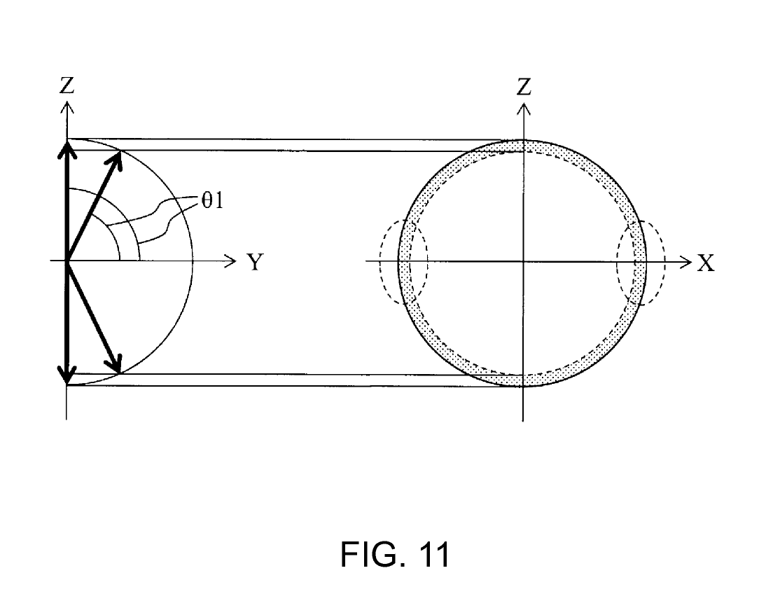

Specifically, as shown in FIG. 11, among light that is emitted from the LEDs at an angle θ1 (an angle within 65° to 90°, for example), the light at the horizontal portions of the circumference (the portions of light surrounded by a dotted line in the areas with hatching) causes V-shaped bright lines, for example. FIG. 11 is a view of the angular distribution of light emitted from an LED.

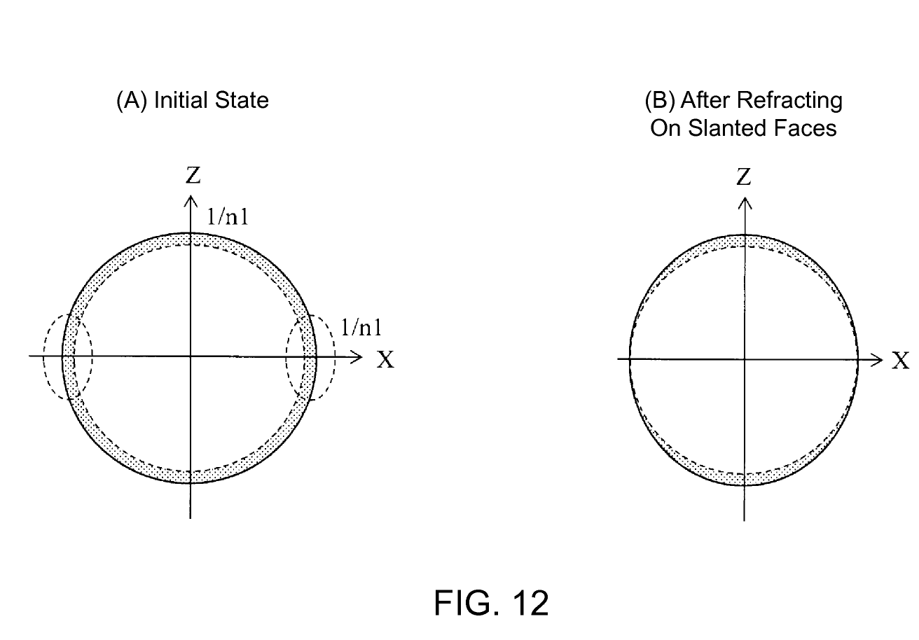

FIG. 12 shows the angular distribution of light inside the light guide plate. FIG. 12(A) is a view of an initial state before light at the horizontal portions of the circumference have passed through protrusions (trapezoidal prisms), and FIG. 12(B) is a view of a state after light at the horizontal portions of the circumference has been refracted at the protrusions (after refraction at the slanted faces). As shown in FIG. 12, the light at the horizontal portions of the circumference is refracted when passing through the side faces 21 and 21 (see FIG. 10) and when passing through the end face 18, thereby changing the angular distribution of the light. Due to this, the light at the angle of the horizontal portions has an angle of incidence with respect to the rear surface 13c (see FIG. 2) that becomes larger than the critical angle of the light guide body 13 and the low refractive index layer 14.

Therefore, light reflected forward by the rear prisms 14b (see FIG. 4.) is suppressed in the vicinity of the light receiving section 13a. Accordingly, this suppresses V-shaped bright lines from occurring. In this manner, by forming the protrusions 20 (see FIG. 10), light having a distribution that will cause V-shaped bright lines is refracted at the protrusions 20 and changed to light having a distribution that will not cause V-shaped bright lines, thereby preventing V-shaped bright lines and making use of this light.

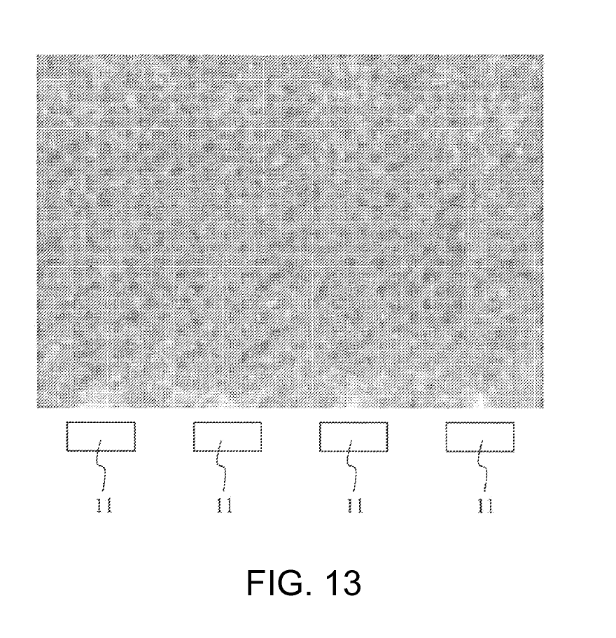

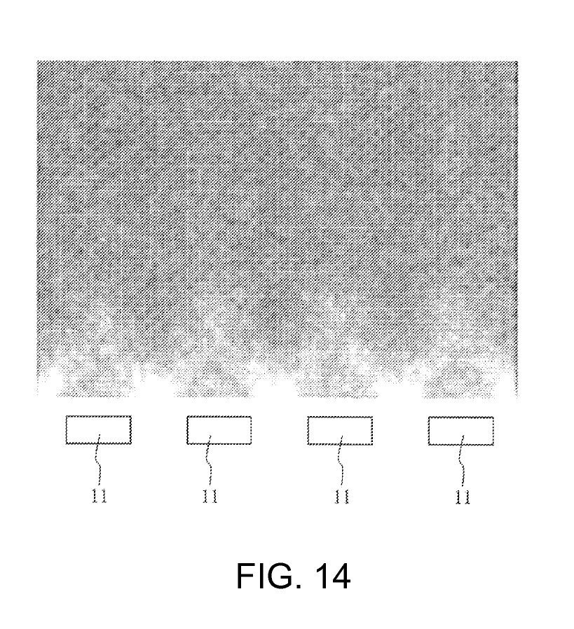

The inhibitory effects of the protrusions 20 (see FIG. 10) on V-shaped bright lines were confirmed by simulation. In the simulation, a configuration having the light guide plate 12 with the protrusions 20 was used as the working example, and a configuration similar to this configuration except for not having the protrusions 20 was used at the comparison example. The results are shown in FIGS. 13 and 14. As shown in FIG. 13, in the working example having the protrusions (see FIG. 10), V-shaped bright lines are not observed, and it was confirmed that the light was high-quality planar light having little uneven brightness. In contrast, in the comparison example in FIG. 14, V-shaped bright lines were observed, which resulted in uneven brightness being caused by these V-shaped bright lines. Thus, it was confirmed that the occurrence of V-shaped bright lines and uneven brightness is suppressed by providing the protrusions 20 (see FIG. 10) on the light guide plate.

By providing the protrusions 20 having the side faces 21 and 21 that respectively slant towards the optical axis O1 on the light guide plate 12, light refracts in a direction approaching the optical axis when passing through these side faces 21 and 21 and when passing through the end face 18. This makes it possible to change light having a brightness distribution that will cause V-shaped bright lines into light having an angular distribution that will not cause V-shaped bright lines. Accordingly, it is possible to suppress the occurrence of V-shaped bright lines; therefore, it is possible to suppress the occurrence of uneven brightness caused by V-shaped bright lines in the planar light exiting from the backlight unit 10. As a result, it is possible to obtain the backlight unit 10, which has high uniformity of brightness. Furthermore, light that would have become V-shaped bright lines can be effectively used, thus allowing for an effective improvement in light use efficiency and brightness.

In the present embodiment, it is possible to suppress the occurrence of V-shaped bright lines by forming the side faces 21 and 21 of the protrusions on the light guide plate 12 such that the side faces become closer to the optical axis O1 from the light receiving section 23a towards the end face 18. This makes it possible to suppress the occurrence of uneven brightness of planar light exiting from the light guide plate 12.

In the backlight unit 10 according to the present invention, it is not necessary to provide a plurality of optical sheets, which makes it possible for the backlight unit to be made thinner and for an increase in manufacturing costs to be suppressed. Light use efficiency can also be improved due in this regard due to not having light passing through the optical sheets.

### Embodiment 2

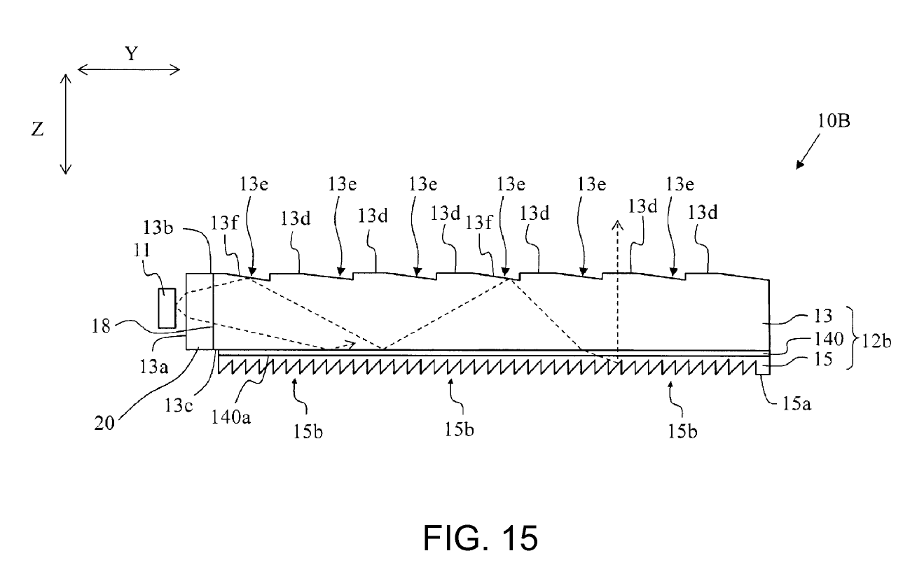

Another example of an illumination device according to the present invention will be explained below with reference to the drawings. FIG. 15 is a side face view of one example of the light guide plate used in the backlight unit (illumination device) of the present invention. A backlight unit 10B shown in FIG. 15 has the same configuration as the backlight unit 10 except in regards to a low refractive index layer 140 and a prism layer 15, and the same reference characters are given to parts that are substantially the same, and a detailed explanation of these same parts will not be repeated.

As shown in FIG. 15, a light guide plate 12b of the backlight unit 10B includes a light guide body 13, the low refractive index layer 140, and the prism layer 15. Specifically, the low refractive index layer 140 is attached to the rear surface of the light guide body 13, and the prism layer 15 is attached to the surface of the low refractive index layer 140 opposite to the light guide body 13.

Prisms 15b having a similar shape to the low refractive index layer 14 of the backlight unit 10 shown in FIG. 2 and the like are formed on the surface of the prism layer 15 opposite to the low refractive index layer 140. If the refractive index of the light guide body is (n1), the refractive index of the low refractive index layer 14 is (n2), and the refractive index of the prism layer 15 is (n3), then it is preferable that these have a relationship of n2<n3≦n1. The prisms 15b are each constituted of a slanted face 15c that slants towards a rear surface 15a and a vertical face 15d that is perpendicular to the rear surface 15a.

In the backlight unit 10B, light emitted from LEDs 21 is repeatedly reflected between a light exiting section 13b and a rear surface 13c of the light guide body 13, thereby gradually narrowing the angle of incidence of the light from the LEDs with respect to the rear surface 13c of the light guide body 13 such that the light enters the low refractive index layer 140. The prism layer 15 has a refractive index that is greater than the low refractive index layer 140; thus, light that has entered the low refractive index layer 140 enters the prism layer 15 without being totally reflected at a rear surface 140a of the low refractive index layer 140 (the interface of the low refractive index layer 140 and the prism layer 15).

Thereafter, substantially all of the light that has entered the prism layer 15 is totally reflected forward by the prisms 15b, or totally reflected after passing therethrough. The concentrated light again enters the low refractive index layer 140 and the light guide body 13 and exits forward from the light exiting section 13b.

In the present embodiment, as described above, the prism layer 15 is provided on the rear surface 140a of the low refractive index layer 140 without an air layer therebetween, and the prisms 15b are formed on the rear surface 15a of the prism layer 15. Due to this, it is not necessary to provide prisms on the low refractive index layer 140, which makes it possible to reduce the thickness of the low refractive index layer 140. Many of the transmissive materials having a relatively low refractive index, such as those used for the low refractive index layer 140, are expensive, and reducing the thickness of the low refractive index layer 140 by providing the prism layer 15 makes it possible to suppress an increase in manufacturing costs of the light guide plate 12b.

Other structures and effects in Embodiment 2 are similar to Embodiment 1 described above.

### Embodiment 3

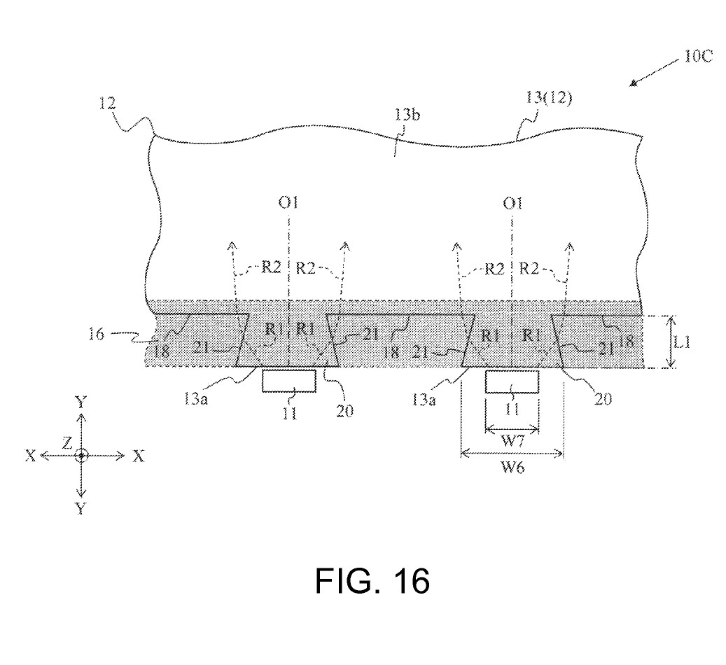

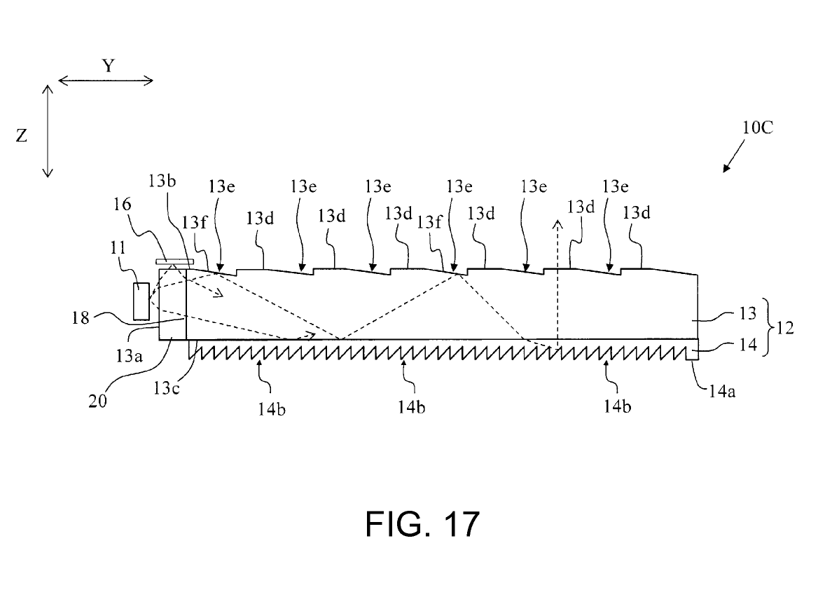

Another example of an illumination device according to the present invention will be explained below with reference to the drawings. FIG. 16 is a front view of another example of the backlight unit (illumination device) of the present invention, and FIG. 17 is a side view of the backlight unit shown in FIG. 16. A backlight unit 10C shown in FIGS. 16 and 17 has the same configuration as the backlight unit 10 except for having a reflective member 16. In the explanation below, the same reference characters are given to parts that are substantially the same as the backlight unit 10, and a detailed explanation of the same parts will not be repeated. Furthermore, in FIG. 16, hatching has been used to help show the reflective member 16 for clarity of explanation.

Light that is emitted from LEDs 11 and enters a light guide body 13 appears as V-shaped bright lines at spread angles of approximately ±39° from an optical axis, as described above. In this range, light that is emitted has a high intensity. The LEDs 11, however, also illuminate portions outside of this angle with a low intensity.

The light emitted to outside of the light that will become V-shaped bright lines enters the front side of the light guide body 13 (protrusions 20) at an angle of incidence that is smaller than the critical angle, and thus is emitted to outside of the light guide body 13. This light is not diffused inside the light guide body 13 and causes uneven brightness. The protrusions 20 are formed on the light guide body 12, and light that has entered side faces 21 and 21 thereof passes through air. At this time, sometimes a portion of the light that passes through air and moves towards the forward side does not return to the light guide body 12 from an end face 18 of the light guide body 12. Light that does not return to the light guide body 12 travels towards the front side and causes uneven brightness in the planar light, resulting in a loss of the light due to being unable to be used as planar light.

In order to suppress the exiting of light that has not been diffused in the light guide plate 12 by first prisms 13e, second prisms 13i, or rear prisms 14b, the backlight unit 10C has the reflective member 16 that reflects light towards the front surface of the light guide plate 12 on the LED 11 side. Specifically, the reflective member 16 is disposed so as to cover, from the end face 18 to the point of re-entry, the front side of the optical path of light that exits from the front side of the protrusions 20 of the light guide body 13 and the side faces 21 and 21 of the protrusions 20.

The reflective member 16 is constituted of a minor made of a dielectric multi-layer film, a reflective plate having a silver coating, a white PET resin, or the like, for example. The reflective member 16 functions to reflect light that has leaked from the protrusions 20 of the light guide plate 12 towards the front back to the light guide body 13.

In this manner, the light that leaks from the protrusions 20 is returned to the light guide body 13 by the reflective member 16, which can suppress the occurrence of uneven brightness and a decrease in light use efficiency.

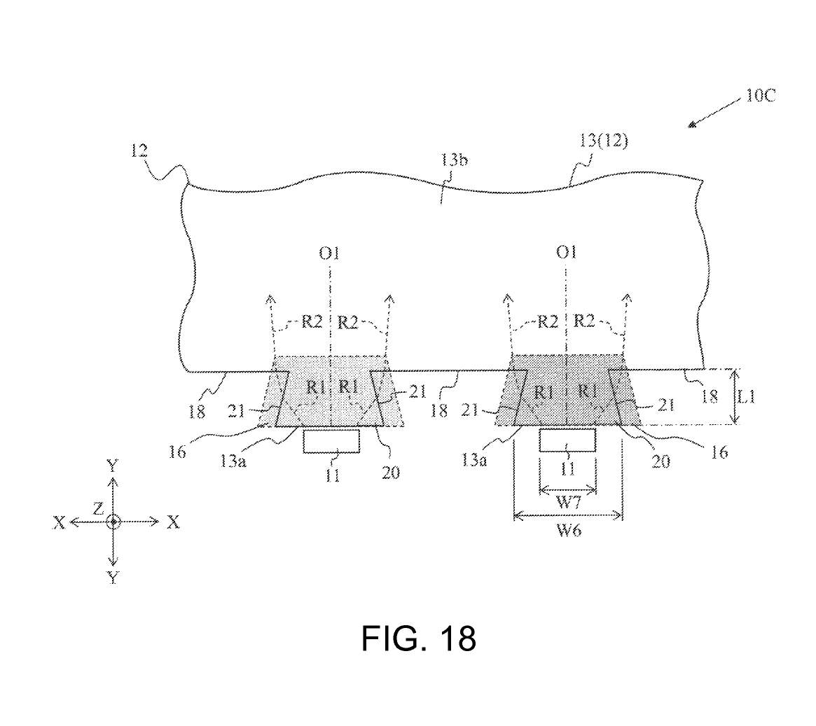

As shown in FIG. 16, the reflective member 16 is disposed so as to cover the entire front side of the end face formed by the protrusions 20 of the light guide body 13, but as shown in FIG. 18, the reflective member 16 may cover only the front side of the protrusions 20 and the front side of the optical path of light emitted from the side faces 21 and 21 to the end face 18. FIG. 18 is a view of a modification example of the backlight unit in FIG. 16.

Other structures and effects in Embodiment 3 are similar to Embodiment 1 described above.

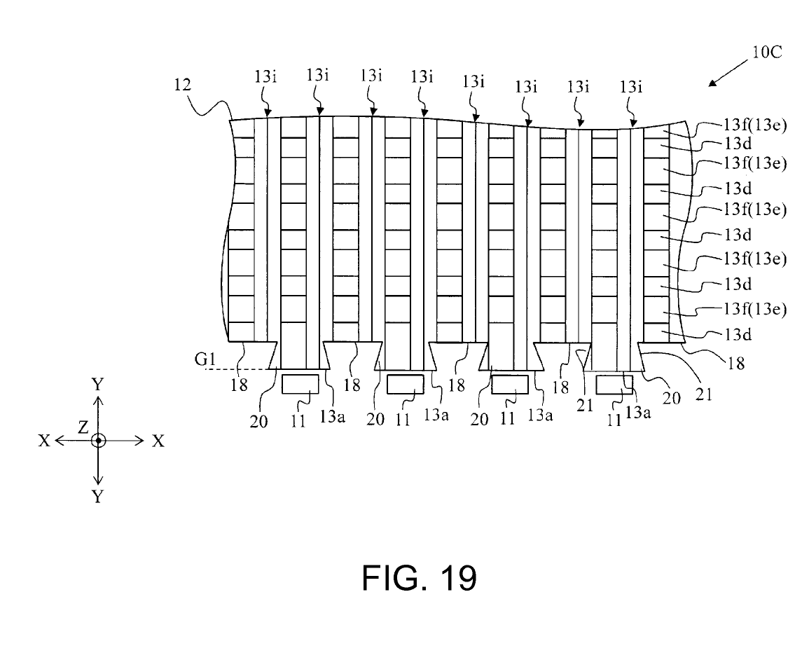

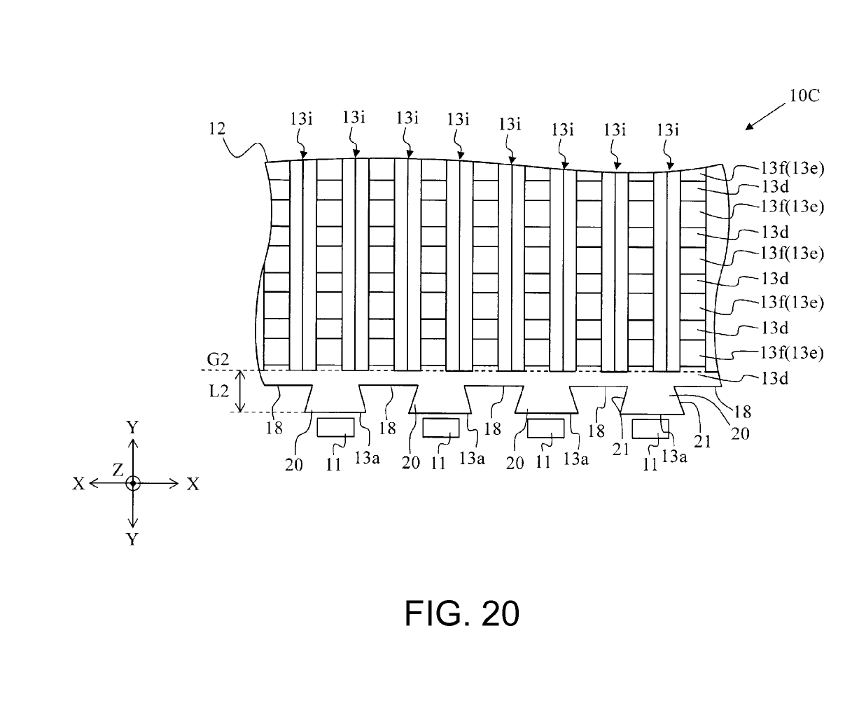

In the respective embodiments above, an example was shown in which the formation areas of the second prisms 13i that horizontally diffuse light are formed up to the end of the slanted faces (trapezoidal prisms), but the present invention is not limited to this, and as shown in FIG. 19, the formation areas of the second prisms 13i may extend to the light receiving section (dotted line G1), for example, or as shown in FIG. 20, may extend to a location (dotted line G2) separated by a prescribed distance L2 (approximately 2 mm, for example) from the light receiving section 13a. The distance L2 can be optimized by a structure between 0 mm to approximately 5 mm, for example.

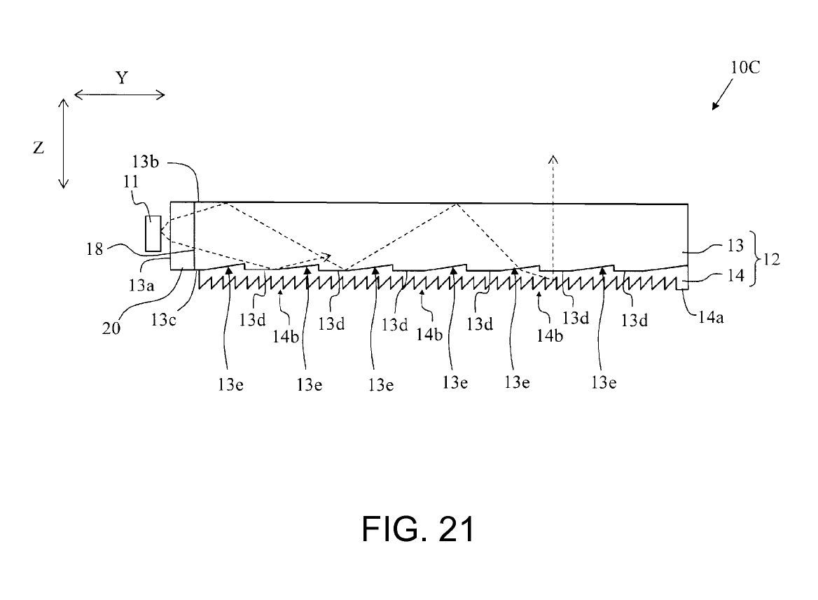

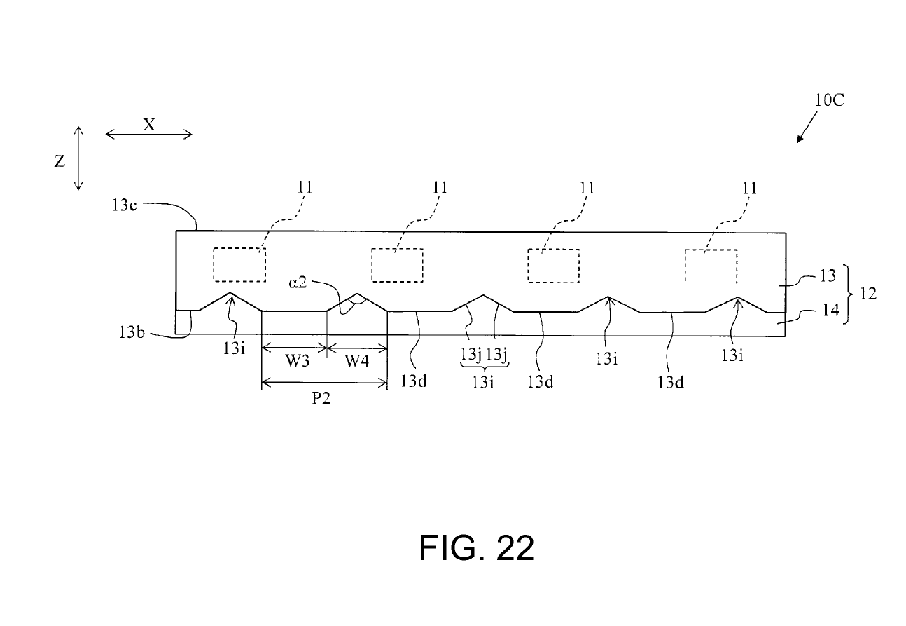

In the respective embodiments above, an example was shown in which prisms that gradually narrow the angle of incidence of light from the LEDs with respect to the rear surface of the light guide body and prisms that diffuse light in the horizontal direction are formed on the light exiting section (front surface) of the light guide body, but the present invention is not limited to this, and the respective prisms may be formed in locations other than the light exiting section (front surface) of the light guide body. As shown in FIG. 21, the first prisms 13e may be formed on the rear surface 13c of the light guide body 13, for example. As shown in FIG. 22, the second prisms 13i may be formed in the rear surface 13c of the light guide body 13. The first prisms 23e and the second prisms 13i may be both be formed on the rear surface 13c of the light guide body 13, or only one may be formed on the rear surface 13c of the light guide body 13.

### Embodiment 4

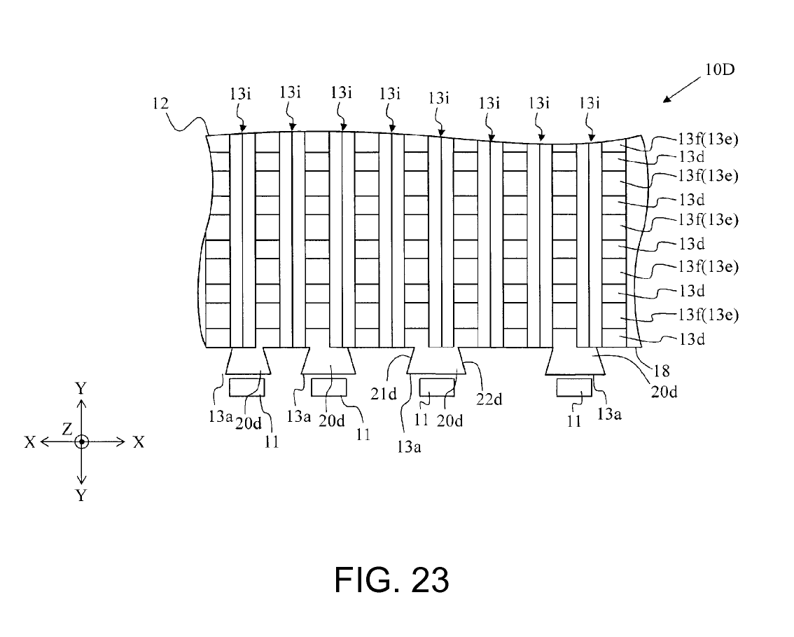

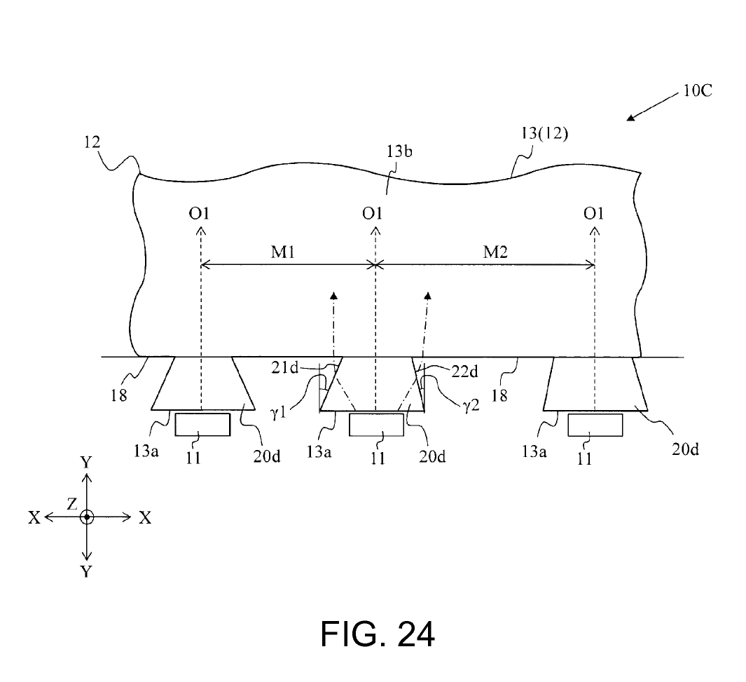

Another example of an illumination device according to the present invention will be explained below with reference to the drawings. FIG. 23 is a front view of another example of the backlight unit (illumination device) of the present invention, and FIG. 24 is a view in which the vicinity of protrusions of the backlight unit of FIG. 23 has been magnified.

As shown in FIG. 23, in a backlight unit 10D, the arrangement gaps of LEDs 11 differ depending on location. Human eyes recognize images having bright centers as bright images more than images having bright peripheries. In the backlight unit 10D, the arrangement gaps of the LEDs 11 are narrower in the center and wider at the ends in order to increase brightness at the center, so as fit with the above-mentioned characteristic of human eyes.

When the arrangement gaps of the LEDs 11 differ, the appearance of the V-shaped bright lines described above will also differ from the backlight unit 10 and the like, in which the LEDs 11 are arranged at equal distances. In other words, in areas where the arrangement gaps of the LEDs 11 are narrow, the intersection of the V-shaped bright lines emitted from the adjacent LEDs 11 is closer to an end face 18 than the areas where the arrangement gaps of the LEDs 11 are wide.

Therefore, in the backlight unit 10D, the slant angles of side faces 21d and 22d of the protrusions 20d with respect to the end face 18 differ from each other. The slant angles of the side faces 21d and 22d will be explained. FIG. 24 is a view in which three of the protrusions 20d have been have been arranged next to each other. In the explanation below, the protrusion 20d disposed in the center of the three protrusions 20d will primarily be described, but the other protrusions have a similar configuration.

In the explanation below and in FIG. 24, the gap between the left protrusion 20d and the center protrusion 20d is M1, and the gap between the center protrusion 20d and the right protrusion 20d is M2, and M1<M2.

The angle (slant angle) γ1 of the left first side face 21d of the center protrusion 20d with respect to the optical axis of the LED 11 is greater than the angle (slant angle) γ2 of the right side second side face 22d of the center protrusion 20d with respect to the optical axis of the LED 11. As shown in FIG. 24, the light that exits from the first side face 21d enters a portion of the end face 18 closer to the second protrusion 20d, as compared to the light exiting from the second slanted face 32d.

Due to this, the side face 21d that is arranged closer to the adjacent protrusion 20d has the slant angle γ1 thereof with respect to the optical axis O1 made large, and the side face 22d that has an open gap with the adjacent protrusion 20d has the slant angle γ2 thereof with respect to the optical axis O1 made small, thereby making it so the light emitted from the LEDs 11 does not mix and is parallel inside the light guide plate 12, even if the LEDs 11 are not arranged at equal distances to each other. Due to this, the backlight unit 10D in which LEDs 11 are arranged at unequal distances to each other can suppress the occurrence of V-shaped bright lines and uneven brightness of planar light.

Other structures and effects in Embodiment 4 are similar to Embodiment 1 described above.

### Embodiment 5

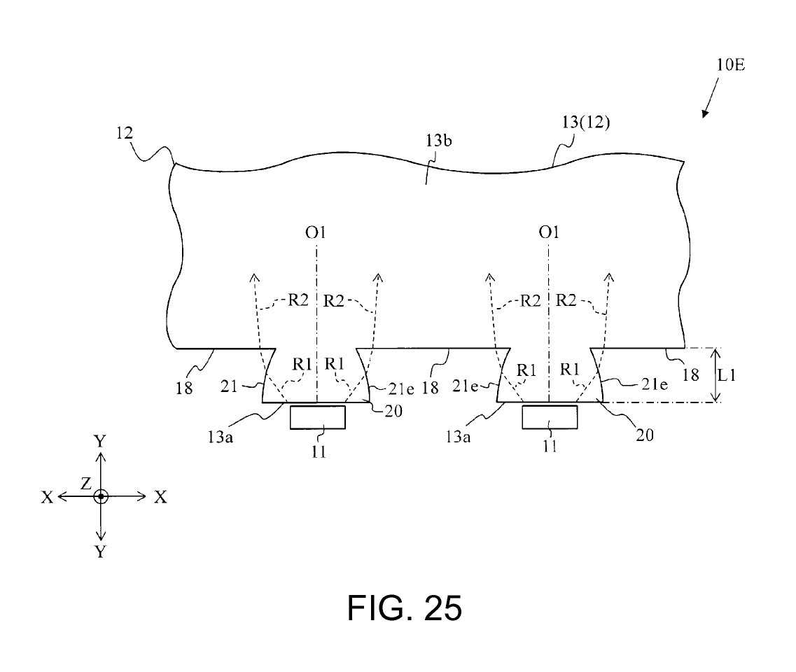

Another example of an illumination device according to the present invention will be explained below with reference to the drawings. FIG. 25 is a front view of another example of the backlight unit (illumination device) of the present invention. A backlight unit 10E shown in FIG. 25 has the same structure as a backlight unit 10 except for the shape of protrusions 20e being different, and the same reference characters are given to parts that are substantially the same, and a detailed explanation of the parts that are the same will not be repeated.

As shown in FIG. 25, side faces 21e of the protrusions 20e are formed in a curved shape. By forming the side faces 21e in a curved shape, it is possible to make the light entering an end face 18 to enter near or far from the protrusions 20e. By adjusting the shape of the curved side faces, it is possible to adjust the angular distribution of light entering the end face 18.

Due to this, even if the spacing between the protrusions 20e (spacing between the LEDs 11) is not equal, light emitted from LEDs 11 does not mix and is parallel inside the light guide plate 12. Due this, the backlight unit 10E in which the LEDs 11 are arranged at unequal distances to each other can suppress the occurrence of V-shaped bright lines and uneven brightness of planar light.

It is also possible to adjust the intensity of the light entering inside the light guide plate 12; therefore, the progression of the light from the LEDs 11 can be adjusted such that the occurrence of V-shaped bright lines is suppressed and a desired angular distribution of the planar light is obtained, without changing the spacing of the LEDs 11.

Other structures and effects in Embodiment 5 are similar to Embodiment 1 described above.

### Embodiment 6

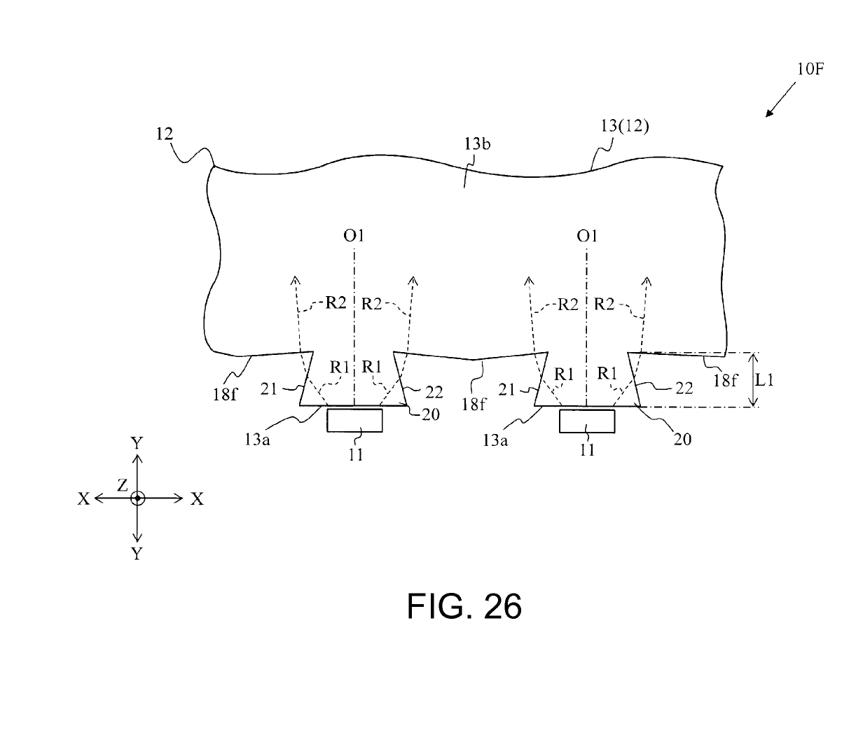

Another example of an illumination device according to the present invention will be explained below with reference to the drawings. FIG. 26 is a front view of another example of the backlight unit (illumination device) of the present invention. A backlight unit 10F shown in FIG. 26 has the same structure as a backlight unit 10 except for the shape of an end face 18f being different, and the same reference characters are given to parts that are substantially the same, and a detailed explanation of the parts that are the same will not be repeated.

As shown in FIG. 26, in the backlight unit 10F, the end face 18f of a light guide plate 12 has a protrusion-like shape. In this manner, by forming the end face 18f in a protrusion-like shape, it is possible to suppress the light emitted from the adjacent LEDs 11 from mixing together even if it is not possible to secure sufficient gaps between the adjacent protrusions and even if the length of the protrusions of the protrusions 20 are not sufficiently long enough.

Due this, the backlight unit 10F in which the LEDs 11 are arranged at unequal distances to each other or at a high density can suppress the occurrence of V-shaped bright lines and uneven brightness of planar light.

The shape of the end face 18f may be a shape that links two faces, such as in FIG. 26, or a shape that links a plurality of faces so as to form a protrusion as a whole. The shape of the end face 18f may also be curved.

Other structures and effects in Embodiment 6 are similar to Embodiment 1 described above.

### Embodiment 7

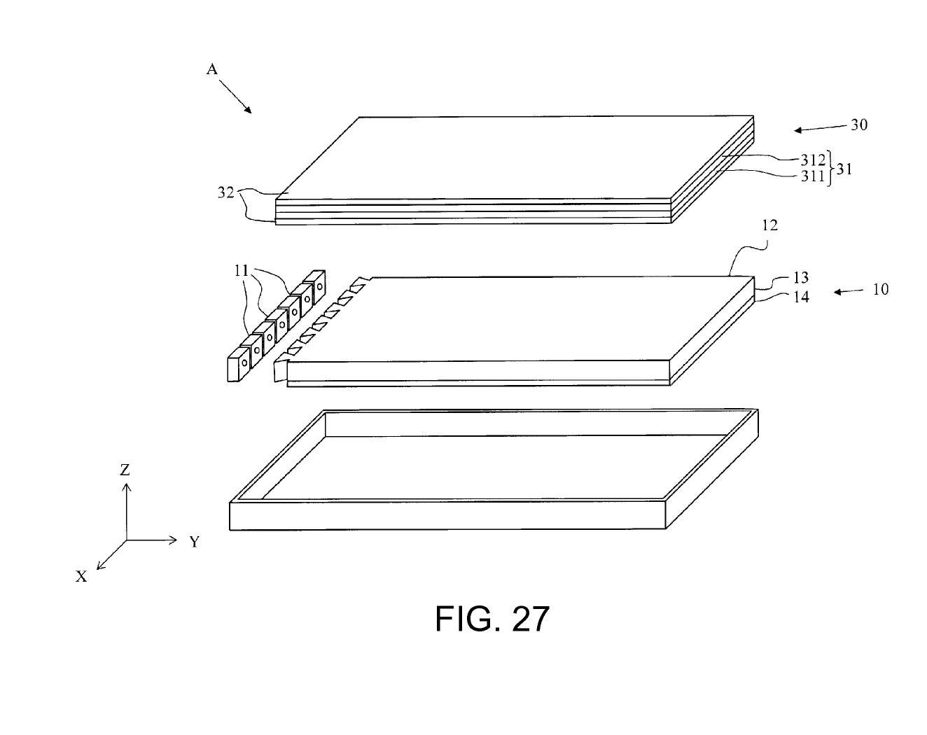

An example of a liquid crystal display device having the backlight unit according to the present invention will be explained with reference to the drawings. FIG. 27 is an exploded perspective view of a liquid crystal display device, which is one example of a display device, according to the present invention. Any configuration of the backlight units 10 to 10F described in the respective embodiments above can be used in the liquid crystal display device of the present invention, but in a liquid crystal display device A of the present embodiment, the backlight unit 10 is used as an example.

As shown in FIG. 27, the liquid crystal display device A according to the present invention has a liquid crystal panel unit 30 disposed on the front side of the backlight unit 10. The liquid crystal panel unit 30 has a liquid crystal panel 31 in which liquid crystal is sealed, and polarizing plates 32 attached to the front (viewer's side) and rear (backlight unit 10 side) of the liquid crystal panel 31. The liquid crystal panel 31 includes an array substrate 311, an opposite substrate 312 that faces the array substrate 311, and a liquid crystal layer (not shown) filled between the array substrate 311 and the opposite substrate 312.

Provided on the array substrate 311 are: mutually intersecting source wiring lines and gate wiring lines; switching elements (thin-film transistors, for example) that are each connected to the respective source wiring lines and gate wiring lines; pixel electrodes that are each connected to the respective switching elements; an alignment film; and the like. Provided on the opposite substrate 312 are: color filters in which respective colored parts of red, green, and blue (RGB) are arranged in prescribed arrays; a common electrode; an alignment film; and the like.

By driving the switching elements of the array substrate 311 with driving signals, a voltage is applied between the respective pixels on the array substrate 311 and the opposite substrate 312 of the liquid crystal panel 31. The degree of transmittance of light of the pixels is changed by varying the voltage between the array substrate 311 and the opposite substrate 312. This causes images to be displayed on the image display region on the viewer's side of the liquid crystal panel 31.

Uneven brightness in the planar light that enters the liquid crystal display unit 30 is suppressed by the backlight unit 10 of the present invention; therefore, it is possible to suppress uneven brightness in images displayed by the liquid crystal display device. In the backlight unit 10, light emitted by the LEDs 11 has a high use efficiency, thus allowing for energy consumption of the liquid crystal display device A to be reduced.

In the respective embodiments above, a liquid crystal display device was explained as an image display device using the illumination device of the present invention, but without being limited thereto, the illumination device of the present invention may be widely used in a transmissive image display device.

Embodiments of the present invention were described above, but the present invention is not limited to the above embodiments. The present invention can have various modifications without departing from the spirit thereof.

### INDUSTRIAL APPLICABILITY

The backlight and liquid crystal display device according to the present invention can be used as a display part for electronic devices such as information appliances, notebook PCs, mobile phones, and gaming devices.

### DESCRIPTION OF REFERENCE CHARACTERS

10 backlight unit
11 LED
12 light guide plate
13 light guide body
14 low refractive index layer
140 low refractive index layer
15 prism layer
16 reflective member
20 protrusion
21 slanted face
30 liquid crystal panel unit
31 liquid crystal panel
311 array substrate
312 opposite substrate

1. An illumination device, comprising:
a plurality of light sources arranged in a line; and
a light guide member disposed adjacent to the light sources to guide light from the light sources;
wherein the light guide member has protrusions that protrude towards the respective light sources from an end face of the light guide member adjacent to said light sources, the light from the light sources entering the respective protrusions, and
wherein the protrusions of the light guide member each have side faces formed such that, among the light that has entered the respective protrusions, light spreading in an arrangement direction of the light sources exits from the side faces to outside of the respective protrusions and then re-enters the light guide member at the end face thereof.

2. The illumination device according to claim 1, wherein the protrusions each have a light receiving face where the light from the respective light sources enters, and
wherein a width of the light receiving face is greater than a width of a light emitting part of the respective light sources.

3. The illumination device according to claim 1, wherein the side faces of the respective protrusions are formed so as to be progressively closer to an optical axis of the light of the respective light sources further away from said light sources.

4. The illumination device according to claim 1, wherein the side faces of the respective protrusions include a first side face and a second side face that are symmetric with an optical axis of the light from the respective light sources.

5. The illumination device according to claim 1,
wherein each of the protrusions is formed in a trapezoidal shape as seen from a front thereof, and
wherein slants of the trapezoidal-shaped protrusions are the side faces of the protrusions.

6. The illumination device according to claim 1, wherein an angle of the respective side faces to an optical axis of the light from the respective light sources is configured such that light that has re-entered from the end face of the light guide member is substantially parallel to said optical axis and does not mix with light from adjacent light sources.

7. The illumination device according to claim 1, further comprising a reflective member that covers at least the side faces of the protrusions and a front side of a portion of the end face of the light guide member where light re-enters.

8. The illumination device according to claim 1,
wherein the light guide member comprises a light guide body where the light from the light sources enters, and a low refractive index layer that is disposed on a rear surface of the light guide body without having an air layer therebetween and that has a lower refractive index than the light guide body.

9. The illumination device according to claim 8, further comprising a prism layer formed on a surface of the low refractive index layer opposite to the light guide body without having an air layer therebetween, said prism layer having prisms on a side thereof opposite to the low refractive index layer.

10. A display device, comprising:
the illumination device according to claim 1, and
a display panel that receives light from said illumination device.

11. The illumination device according to claim 2, wherein the side faces of the respective protrusions are formed so as to be progressively closer to an optical axis of the light of the respective light sources further away from said light sources.

12. The illumination device according to claim 2, wherein the side faces of the respective protrusions include a first side face and a second side face that are symmetric with an optical axis of the light from the respective light sources.

13. The illumination device according to claim 2, wherein an angle of the respective side faces to an optical axis of the light from the respective light sources is configured such that light that has re-entered from the end face of the light guide member is substantially parallel to said optical axis and does not mix with light from adjacent light sources.

14. The illumination device according to claim 3, wherein an angle of the respective side faces to the optical axis of the light from the respective light sources is configured such that light that has re-entered from the end face of the light guide member is substantially parallel to said optical axis and does not mix with light from adjacent light sources.

15. The illumination device according to claim 11, wherein an angle of the respective side faces to the optical axis of the light from the respective light sources is configured such that light that has re-entered from the end face of the light guide member is substantially parallel to said optical axis and does not mix with light from adjacent light sources.

16. The illumination device according to claim 4, wherein an angle of the respective side faces to the optical axis of the light from the respective light sources is configured such that light that has re-entered from the end face of the light guide member is substantially parallel to said optical axis and does not mix with light from adjacent light sources.

17. The illumination device according to claim 12, wherein an angle of the respective side faces to the optical axis of the light from the respective light sources is configured such that light that has re-entered from the end face of the light guide member is substantially parallel to said optical axis and does not mix with light from adjacent light sources.

18. The illumination device according to claim 5, wherein an angle of the respective side faces to an optical axis of the light from the respective light sources is configured such that light that has re-entered from the end face of the light guide member is substantially parallel to said optical axis and does not mix with light from adjacent light sources.
